(19) United States
(12) Patent Application Publication
(10) Pub. No.: US 2013/0198566 A1
(43) Pub. Date: Aug. 1, 2013

(54) Method and Apparatus for Debugging System-on-Chip Devices

(71) Applicants: Sachin Shivanand Bastimane, Pune (IN); Hemang Rajnikant Desai, Mumbai (IN)

(72) Inventors: Sachin Shivanand Bastimane, Pune (IN); Hemang Rajnikant Desai, Mumbai (IN)

(73) Assignee: LSI CORPORATION, Milpitas, CA (US)

(21) Appl. No.: 13/359,895

(22) Filed: Jan. 27, 2012

(51) Int. Cl. G06F 11/27

(52) U.S. Cl. 714/30; 714/E11.169

(57) ABSTRACT

A device that provides debug mode information associated with a System-on-Chip (SoC) device includes a multiplexer, debug controller, and a memory device internal to the SoC device and coupled to the multiplexer. The multiplexer directs debug mode information to the memory device in response to the SoC device being in a debug mode. The debug controller stores the debug mode information in the memory device in response to a triggering signal, and the triggering signal is associated with a triggering event. The debug controller reads data from memory device and provides the debug mode information external to the SoC device. The memory may include a first memory block and a second memory block, which store debug mode information. The first memory block may store debug mode information, and the second memory block may store normal mode information. A corresponding method and computer-readable medium are also disclosed.

### BACKGROUND

1. Field

The present invention generally relates to electrical and electronic devices and circuits, and more particularly relates to debugging System-on-Chip (SoC) devices.

2. Related Art

During the silicon testing phase of SoC devices, many engineering man-hours are typically required to debug device failures and fix their causes. These failures are often very difficult to debug due, primarily, to a lack of external access and visibility to signals internal to the SoC device.

Multi-million dollar automatic test equipment (ATE) setups are generally used to debug SoC device failures. Using these testers costs at least $100 to $200 per hour, which can result in tens of thousands of dollars to complete the debug phase of a given design. The debugging of failures not only adds substantial cost to SoC device development, but also causes significant time-to-market delays, which typically result in a loss of substantial market share and potentially missing an entire window of opportunity for a particular device.

Many of the issues at the root of such failures are located in one or more of the respective functional blocks within the SoC device, such as, but not limited to, a hard disk controller (HDC), double data rate (DDR) synchronous dynamic ram controller, read channel (RDC), and long latency interface (LLI). LLI is an example of a functional block that may exhibit failures during SoC verification. Thus, to be effective, it would be advantageous to provide SoC designers with greater visibility inside functional blocks within the SoC device, such as providing the status of internal registers during a failure. However, due to severe limitations in input/output pad quantities and routing congestion, it is often difficult to provide a meaningful interface by which the designer can obtain sufficient access to register values internal to the SoC device.

### SUMMARY

Various embodiments of the invention improve the ability to monitor signals and states internal to a System-on-Chip (SoC) device by using a device configured to provide debug information associated with the SoC device, a computer-readable medium storing instructions that, when executed by a processing device, causes the processing device to perform a computer process that provides debug information associated with the SoC device, and a method of providing debug information associated with the SoC device. In this manner, aspects of the embodiments beneficially provide debug information associated with SoC devices.

In accordance with one embodiment of the invention, a device configured to provide debug mode information associated with an SoC device is provided, which includes a multiplexer, debug controller, and memory device operatively coupled to the multiplexer. The memory device is internal to the SoC device, and the multiplexer directs debug mode information to the memory device in response to the SoC device being in a debug mode. The memory device stores the debug mode information in response to a triggering signal, and the triggering signal is associated with a triggering event. The debug controller or debug control logic reads data from the memory device and provides the debug mode information external to the SoC device.

The debug mode information represents a value of a signal associated with the SoC device, value of a register associated with the SoC device, and/or internal state associated with the SoC device. The signal associated with the SoC device is not accessible external to the SoC device, and the register associated with the SoC device is not accessible external to the SoC device. The triggering event includes an interrupt, error condition, signal external to the SoC device, signal under software control, condition of the SoC device, and/or state of the SoC device. The memory includes a first memory block and a second memory block, which store debug mode information. The first memory block stores debug mode information, and the second memory block stores normal mode information.

In accordance with another embodiment of the invention, a method of providing debug mode information associated with an SoC device is provided, which includes storing debug mode information in on-chip memory internal to the SoC device in response to a triggering signal, and providing the debug mode information external to the SoC. The triggering signal represents a triggering event.

In accordance with yet another embodiment of the invention, a computer-readable medium storing instructions that, when executed by a processing device, causes the processing device to perform a computer process that provides debug mode information associated with an SoC device is provided, which includes storing the debug mode information in on-chip memory internal to the SoC device in response to a triggering signal, and providing the debug mode information external to the SoC device.

The following detailed description of embodiments of the invention is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of at least a portion of an exemplary system in accordance with embodiments of the invention disclosed herein;

FIG. 2 is a block diagram of an illustrative automatic test equipment (ATE) setup for use with the embodiments disclosed herein;

FIG. 3 is a flowchart depicting at least a portion of an exemplary high-level method of testing an SoC device for use with the embodiments disclosed herein;

FIG. 4 is a flowchart depicting at least a portion of an exemplary method of obtaining debug data from the SoC device, in accordance with the embodiments disclosed herein;

FIG. 5 is a block diagram of at least a portion of an exemplary device for obtaining debug data from the SoC device, in accordance with the embodiments disclosed herein; and

FIG. 6 is a block diagram of at least a portion of an illustrative embodiment of a machine in the form of a computing system configured to perform the disclosed methods.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

The embodiments herein, will be described in the context of an illustrative System-on-Chip (SoC) device configured to enable debugging information to be stored to and accessed from on-chip memory resident in and/or associated with the SoC device. It should be understood, however, that the embodiments are not limited to these or any other particular circuit arrangements. Rather, the embodiments are more generally applicable to techniques for improving visibility and access to signals and states internal to the SoC device, while beneficially minimizing any additional circuitry, area, and power consumption used to do so. Moreover, it will become apparent to those skilled in the art given the teachings herein that numerous modifications can be made to the embodiments described that are within the scope of the disclosure. That is, no limitations with respect to the specific embodiments described herein are intended or should be inferred.

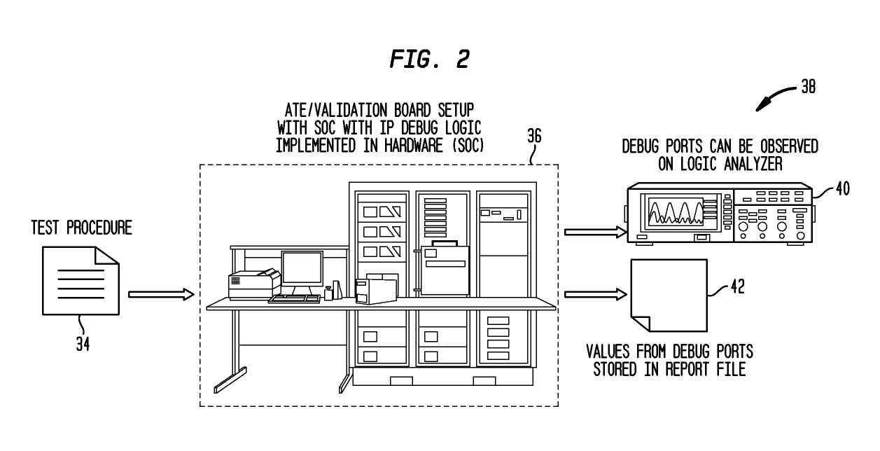

To test and reproduce issues found in SoC devices, a stand-alone test environment 38, such as that shown in FIG. 2, is generally provided for one or more long latency interface (LLI) functional blocks or systems. LLI is an interface defined for the read channel, and is the functional block connected to the read channel long latency interface. LLI is referred to as long latency due to latency between the control gate signals and data. The read channel is an electrical circuit that transforms physical magnetic flux changes into abstract bits. A read error occurs when the physical part of the process fails for some reason, such as dust or dirt entering a memory drive. In this environment, inputs of the LLI functional block are controlled from SoC device level pad inputs, and outputs of the LLI functional block are observed at SoC level pad outputs. To view internal signals of LLI functional blocks during verification, the existing on-chip memory is used in accordance with the embodiments to provide a cost-effective solution requiring minimal additional circuitry and chip area.

The embodiments herein provide a substantial aid in debugging SoC blocks by saving costly resources, such as engineering time. In addition, the embodiments of the invention significantly reduce the number of SoC pads used, which is very important since SoC design area is pad-limited. Further, since internal signals are not required to be brought external to the SoC in the embodiments, any effects on latency and timing concerning the monitored signals are reduced or eliminated, thus providing a more accurate representation of the monitored events. Still further, the embodiments substantially reduce routing congestion and crosstalk within the SoC. Also, the embodiments are readily adaptable and scalable to different SoC blocks with minimal modification to the architecture.

Hard disk drive (HDD) SoC's are developed by integrating multiple functional blocks. These functional blocks are developed by different teams of engineers. However, each of the teams is typically responsible for verification of their respective functional block. Thus, top-level test cases are generally performed to ensure that connections between functional blocks are correct with respect to timing and continuity.

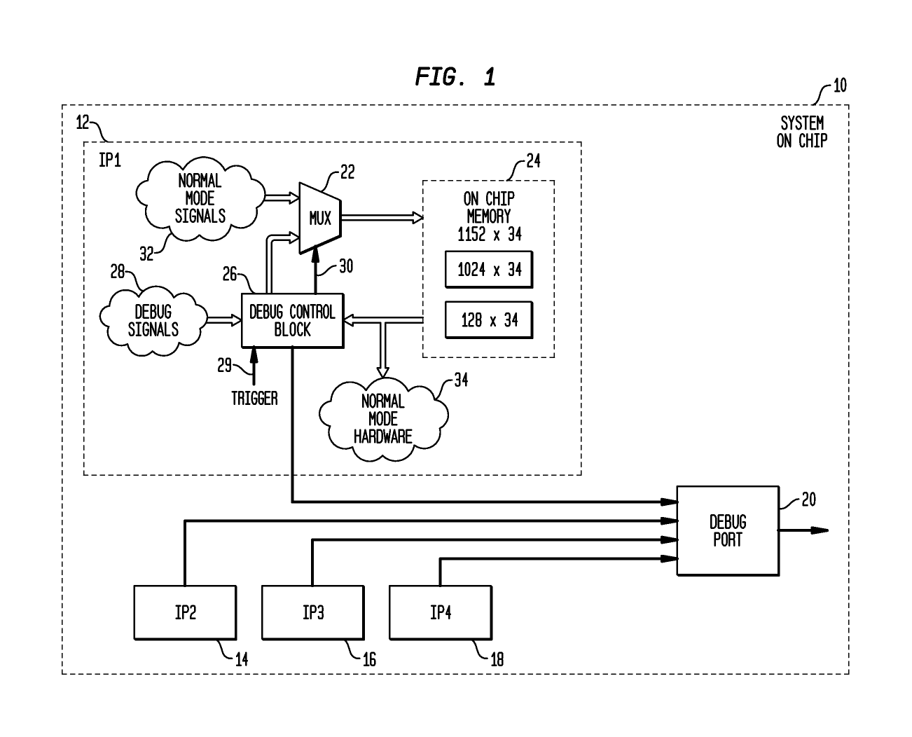

FIG. 1 is a block diagram of an SoC device 10, in which an embodiment is implemented. The SoC device 10 includes functional blocks IP1-IP4 12, 14, 16, 18 operatively coupled to a debug port 20. Functional block IP1 12 includes a multiplexer 22, on-chip memory 24, and a debug control block, debug control logic, or debug controller 26. Debug signals 28 from the functional block IP1 12 are input to the debug control block 26, which applies these signals and one or more control signals 30 to the multiplexer 22. The multiplexer 22 selectively applies signals from the debug control block 26 or normal mode signals 32 from the functional block IP1 12 to the on-chip memory 24 in accordance with the control signals 30 from the debug control block 26. For example, if the functional block IP1 12 is placed in normal mode, during which this block performs operations and/or functions during normal operation of the SoC device 10, then the control signals 30 from the debug control block 26 will control the multiplexer 22 to pass the normal mode signals 32 to the on-chip memory 24. Conversely, if the functional block IP1 12 is placed in debug mode, during which this block performs operations and/or functions during debug of the SoC device 10, the control signals 30 will control the multiplexer 22 to pass the debug mode signals 28 to the on-chip memory 24, which occurs in response to a triggering event. A normal mode hardware block 34 interfaces with the on-chip memory 24 to access its contents during the normal mode. The debug control block 26 obtains debug information, such as values of debug signals stored in on-chip memory 24 and provides the debug information to the debug port 20.

The memory 24 includes a 1024×34 bit memory block and a 128×34 bit memory block for a total of 1152×34 bits of memory. In a first embodiment, the 128×34 bit memory block is used to store debug mode data, such as information concerning internal registers, signals, and/or states, and the 1024×34 bit memory block is used to store normal mode data, rather than both memories storing debug mode data. In the debug mode of the first embodiment, normal mode data stored in the 1024×34 bit memory block is not lost. However, less debug mode data can be stored in this embodiment. In a second embodiment, both memories are used for storing debug mode data in response to the triggering event, which results in more debug data that can be saved. In the second embodiment, the 128×34 bit memory block is used to store information concerning internal registers, signals, and/or states, and the information stored in the 1152×34 bit memory block includes state machine register values, internal counters, error registers, and internal registers that are very helpful for debugging functional blocks in the SoC environment. However, in the second embodiment, normal mode data is lost in response to the triggering event. In normal mode the 1152×34 bit memory is used, which includes the 1024×34 bit memory block and the 128×34 bit memory block.

Alternatively, if a processor (not shown) is provided on the SoC device 10, the processor is used to read debug mode data or information from the on-chip memory 24 and provide the debug information to the debug port 20 and/or an alternative interface. As another alternative a separate interface is used to read debug data from the on-chip memory 24, such as a joint test action group (JTAG), inter-ic (I2C), and/or other proprietary interface protocols. Thus, the on-chip memory 24 is used to store debug information to aid in debugging failures associated with the SoC device 10.

I2C refers to a type of bus used to connect integrated circuits (IC). I2C is a multi-master bus, which means that multiple chips are connected to the same bus and each chip can act as a master by initiating a data transfer. I2C is used in many devices, especially video devices, such as computer monitors, televisions and video recorders.

The debug control block 26 is triggered in response to any event, such as internally or externally generated interrupts, error conditions, debug signals from external devices to the SoC device 10, debug signals under software control, conditions, or status of the SoC device 10, and the like. The triggering signal are generated internally by the debug control block 26 or applied as a triggering signal 29 external to the debug control block 26. The on-chip memory 24 used to store the debug information is any type of memory, such as single-port memory, dual-port memory, cache memory, and the like.

The embodiments aid designers in debugging hardware in the SoC environment on automatic test equipment (ATE) setups and/or validation boards. For failures in the SoC device 10, the test will be run on an ATE setup or validation board with the debug mode enabled. A failure is used as a trigger for the debug control block 26 to initiate sampling values of internal registers, internal states, and/or signals associated with the SoC device and storing the sampled values to the on chip memory 24.

To test and reproduce issues found in SoC devices, a stand-alone test environment 38 is provided as shown in FIG. 2 for system level verification. In this test environment 38, the inputs and outputs of, for example, an LLI functional block to be tested are controlled from SoC level inputs and LLI functional block outputs, and are observed at SoC level outputs. Conventional approaches merely provide visibility to output ports that is insufficient for debugging failures. Therefore, to observe internal signals from LLI functional blocks, Soc_tst[1:0] ports are provided, to which internal signals are coupled following multiplexer logic. Soc_tst[1:0] is a dedicated port provided to map internal signals that can be used during the debug mode to locate failures or error conditions. The internal signals that are to be mapped or assigned to Soc_tst[1:0] are determined by a programmable configuration register. Typically, a test plan or program 34 is provided to the ATE setup and/or validation board 36 incorporating the SoC device. The debug information is then monitored using equipment 40, such as logic analyzers, spectrum analyzers, oscilloscopes, and the like. Test reports 42 including the debug information can also be generated in hardcopy or electronic formats for reporting, storage, and/or further analysis.

The disadvantages of using conventional LLI test environments include (1) a limited quantity of input/output signals on the SoC device, which make it impossible to monitor signals and/or states, (2) a limited number of internal signals available to control events during debug, (3) significant latency and difficulty in meeting timing constraints due to multiple layers of multiplexed test signals, and (4) substantially increased routing complexity and congestion, as well as crosstalk due to additional test signals.

To overcome these limitations, the embodiments observe internal signals of functional blocks within the SoC device using memory instantiated in the functional blocks, in which the status of internal registers, signals, and/or states are stored. As discussed above, in the first embodiment, certain portions of memory in the SoC device is retained for use in the debug mode. In the second embodiment, at least a portion of the memory in the SoC device is allocated for holding the status of internal registers, signals, and/or states by disabling one or more existing features in the debug mode, such as by disabling a SeedFifo feature. Sectors written through the read channel can have unique seed values. This seed value is valid during a gate or control signal, and is stored in a FIFO. When corresponding data for the control signal arrives, the seed value is stored in the FIFO, and the value is output to the read channel.

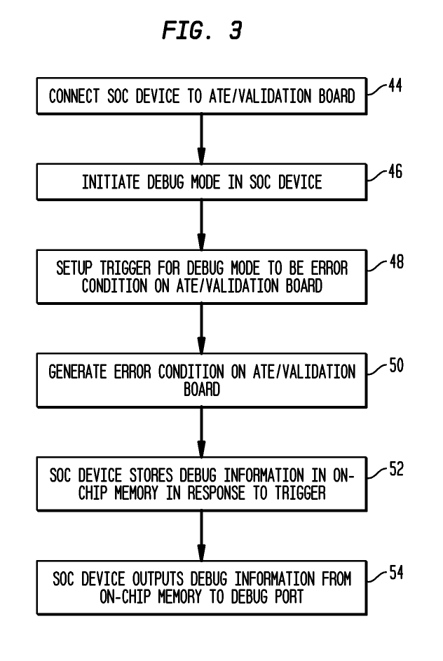

FIG. 3 is a flowchart of a top-level testing procedure in accordance with the embodiments. The SoC device is connected to the ATE and/or validation board in step 44, and the debug mode is initiated in the SoC device in step 46. The event that is to be used to generate a trigger in the debug mode is then defined in step 48, and the error condition that results in generating the trigger is recreated on the ATE and/or validation board in step 50. The SoC device then stores debug information in the on-chip memory in response to receiving the trigger in step 52, and the SoC device outputs debug information from on-chip memory to the debug port or an alternate interface in step 54.

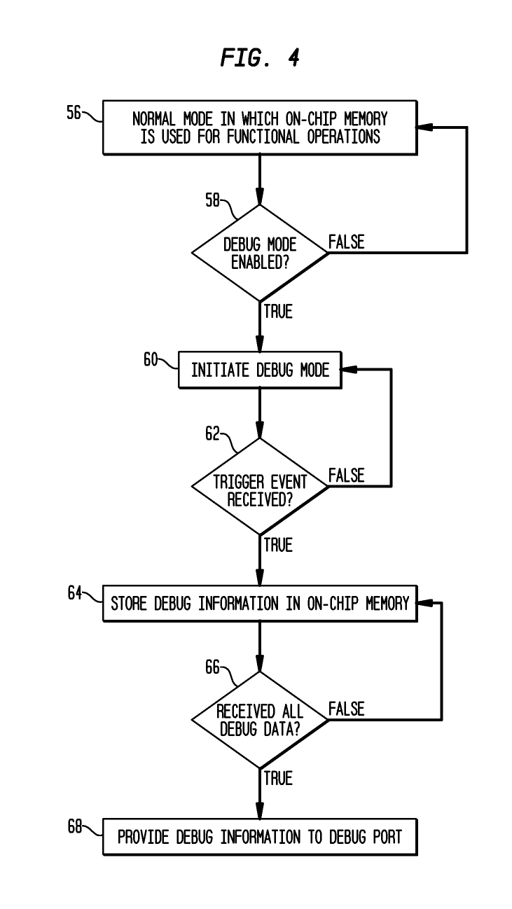

FIG. 4 is a flowchart of a method of storing and providing debug information from an SoC device. The SoC device is in a normal mode in step 56, in which the on-chip memory is being used for ordinary functional operations that the SoC is intended to perform excluding debugging. If the debug mode is enabled in step 58, the SoC device initiates the debug mode in step 60. If a trigger event is provided to the SoC device in step 62, the SoC device will store debug information in on-chip memory in step 64. If the debug data is stored in on-chip memory in step 66, the debug information will be provided to the debug port or an alternative output interface in step 68.

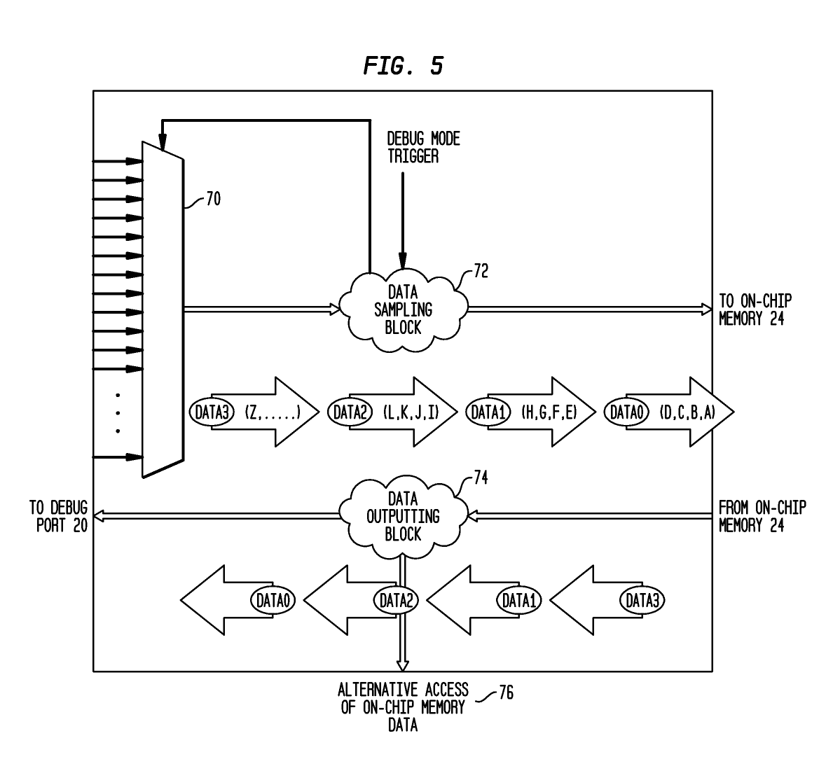

FIG. 5 is a block diagram showing operation of a embodiment, which includes a multiplexer 70, debug data sampling block 72, and debug data outputting block 74. In response to a triggering event or signal that initiates the debug mode, the data sampling block 72 samples current values of internal registers, signals, and/or states and writes these values into the on-chip memory 24. The debug data outputting block 74 includes a serial interface, from which the on-chip memory 24 is read. An error event or interrupt condition, which can also be an external interrupt, is used to trigger the debug data sampling block 72, which will load the internal register, signal, and/or state in the on-chip memory. Following storage of the debug information in the on-chip memory, the debug information will be read back through the serial interface by the debug data outputting block 74. Since the serial interface is also used for reading memory locations during normal mode, the required number of SoC level pins is substantially reduced.

The embodiments provide at least one or more of the following benefits:
a substantial increase in the number of observable internal signals, such as 128×34=4352 signals in the example discussed above;
a substantial reduction in multiplexer logic required for accessing internal signals of the functional block, which results in lower latency added to signal timing paths;
a significant reduction in the complexity of storing multi-bit register values;
a significant reduction in errors when reading modified values following a triggering event due to the debug information being stored in memory rather than being externally sampled; and generic applicability to any SoC device.

A serial interface (not shown) is used to read back contents of the on-chip memory, in which the debug data is stored in accordance with FIG. 5. The serial interface supports single transactions of write or read accesses, in which an eight-bit address is used to access the memory location from which data is to be read. Although the serial interface is provided as an example that can be used to read data from the memory block, alternative interfaces 76 known in the art are also used, such as a joint test action group (JTAG) interface.

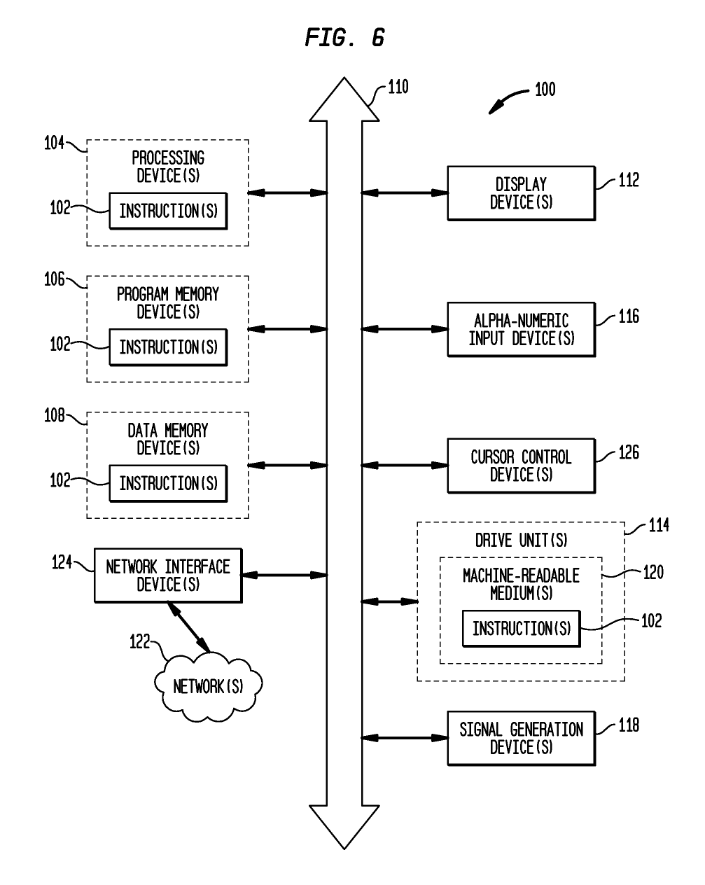

FIG. 6 is a block diagram of an embodiment of a machine in the form of a computing system 100, which incorporates a set of instructions 102, that when executed, cause the machine to perform any one or more of the methodologies herein. In some embodiments, the machine operates as a standalone device. In some embodiments, the machine is connected (e.g., using a network) to other machines. In a networked implementation, the machine operates in the capacity of a server or a client-user machine in a server-client user network environment. The machine includes a server computer, a client-user computer, a personal computer (PC), tablet PC, personal digital assistant (PDA), cellular telephone, mobile device, palmtop computer, laptop computer, desktop computer, communication device, personal trusted device, web appliance, network router, switch or bridge, or any machine capable of executing a set of instructions (sequential or otherwise) that specify actions to be taken by that machine.

The computing system 100 includes a processing device(s) 104 (e.g., a central processing unit (CPU), a graphics processing unit (GPU), or both), program memory device(s) 106, and data memory device(s) 108, which communicate with each other via a bus 110. The computing system 100 further includes display device(s) 112 (e.g., liquid crystals display (LCD), flat panel, solid state display, or cathode ray tube (CRT)). The computing system 100 includes input device(s) 116 (e.g., a keyboard), cursor control device(s) 126 (e.g., a mouse), disk drive unit(s) 114, signal generation device(s) 118 (e.g., a speaker or remote control), and network interface device(s) 124.

The disk drive unit(s) 114 includes machine-readable medium(s) 120, on which is stored one or more sets of instructions 102 (e.g., software) embodying any one or more of the methodologies or functions herein, including those methods illustrated herein. The instructions 102 also reside, completely or at least partially, within the program memory device(s) 106, data memory device(s) 108, and/or within the processing device(s) 104 during execution thereof by the computing system 100. The program memory device(s) 106 and the processing device(s) 104 also constitute machine-readable media. Dedicated hardware implementations, such as but not limited to application specific integrated circuits, programmable logic arrays, and other hardware devices can likewise be constructed to implement the methods described herein. Applications that include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments, the methods, functions or logic described herein are implemented as one or more software programs running on a computer processor. Dedicated hardware implementations including, but not limited to, application specific integrated circuits, programmable logic arrays and other hardware devices can likewise be constructed to implement the methods described herein. Further, alternative software implementations including, but not limited to, distributed processing or component/object distributed processing, parallel processing, or virtual machine processing can also be constructed to implement the methods, functions or logic described herein.

The embodiment contemplates a machine-readable medium or computer-readable medium containing instructions 102, or which receives and executes instructions 102 from a propagated signal so that a device connected to a network environment 122 can send or receive voice, video or data, and to communicate over the network 122 using the instructions 102. The instructions 102 are transmitted or received over the network 122 via the network interface device(s) 124. The machine-readable medium also contain a data structure for storing data useful in providing a functional relationship between the data and a machine or computer in an embodiment herein.

While the machine-readable medium 102 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform anyone or more of the methodologies of the embodiment. The term “machine-readable medium” shall accordingly be taken to include, but not be limited to: solid-state memories, such as a memory card or other package that houses one or more read-only (non-volatile) memories, random access memories, or other re-writable (volatile) memories; magneto-optical or optical medium, such as a disk or tape; and/or a digital file attachment to e-mail or other self-contained information archive or set of archives considered a distribution medium equivalent to a tangible storage medium. Accordingly, the embodiments are considered to include any one or more of a tangible machine-readable medium or a tangible distribution medium, as listed herein including art-recognized equivalents and successor media, in which the software implementations herein are stored.

Although the specification describes components and functions implemented in the embodiments with reference to particular standards and protocols, the embodiments are not limited to such standards and protocols.

The illustrations of embodiments described herein are intended to provide a general understanding of the structure of various embodiments, and they are not intended to serve as a complete description of the elements and features of apparatus and systems that might make use of the structures described herein. Many other embodiments will be apparent to those of skill in the art upon reviewing the above description. Other embodiments are utilized and derived therefrom such that structural and logical substitutions and changes are made without departing from the scope of this disclosure. Figures are also merely representational and are not drawn to scale. Certain proportions thereof are exaggerated, while others are reduced. Accordingly, the specification and drawings are to be regarded in an illustrative rather than a restrictive sense.

Such embodiments of the inventive subject matter are referred to herein, individually and/or collectively, by the term “embodiment” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose is substituted for the specific embodiments shown. This disclosure is intended to cover adaptations or variations of various embodiments.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single embodiment. Thus the following claims are hereby incorporated into the Detailed Description, with each claim standing on its own as a separate example embodiment.

The Abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single embodiment. Thus the following claims are hereby incorporated into the Detailed Description, with each claim standing on its own as separately claimed subject matter.

Although specific example embodiments have been described, it will be evident that various modifications and changes are made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and without limitation, specific embodiments, in which the subject matter is practiced. The embodiments illustrated are described in sufficient detail to enable those skilled in the art to practice the teachings herein. Other embodiments are utilized and derived therefrom, such that structural and logical substitutions and changes are made without departing from the scope of this disclosure. This Detailed Description, therefore, is not to be taken in a limiting sense, and the scope of various embodiments is defined by the appended claims, along with the full range of equivalents to which such claims are entitled.

Given the teachings of the invention provided herein, one of ordinary skill in the art will be able to contemplate other implementations and applications of the techniques of the invention. Although illustrative embodiments of the invention have been described herein with reference to the accompanying drawings, it is to be understood that the invention is not limited to those precise embodiments, and that various other changes and modifications are made therein by one skilled in the art without departing from the scope of the appended claims.

What is claimed is:

1. A method of providing debug mode information associated with a system-on-chip device, the method comprising:
storing debug mode information in on-chip memory internal to the system-on-chip device in response to a triggering signal, the triggering signal being associated with a triggering event and
providing the debug mode information external to the system-on-chip device.

2. The method of providing debug mode information associated with a system-on-chip device defined by claim 1, wherein the debug mode information represents at least one of a value of a signal associated with the system-on-chip device, value of a register associated with the system-on-chip device, and internal state associated with the system-on-chip device.

3. The method of providing debug mode information associated with a system-on-chip device defined by claim 2, wherein the signal associated with the system-on-chip device is not available external to the system-on-chip device.

4. The method of providing debug mode information associated with an system-on-chip device defined by claim 2, wherein the register associated with the system-on-chip device is not available external to the system-on-chip device.

5. The method of providing debug mode information associated with a system-on-chip device defined by claim 1, wherein the triggering event comprises at least one of an interrupt, error condition, signal external to the system-on-chip device, signal under software control, condition of the system-on-chip device, and state of the system-on-chip device.

6. The method of providing debug mode information associated with a system-on-chip device defined by claim 1, wherein the memory comprises a first memory block and a second memory block, the method further comprising storing debug mode information in the first memory block and the second memory block.

7. The method of providing debug mode information associated with a system-on-chip device defined by claim 1, wherein the memory comprises a first memory block and a second memory block, the method further comprising:
storing debug mode information in the first memory block; and
storing normal mode information in the second memory block.

8. A device configured to provide debug mode information associated with a system-on-chip device, the device comprising:
a multiplexer;
a debug controller; and
a memory device operatively coupled to the multiplexer and debug controller, the memory device being internal to the system-on-chip device, the multiplexer directing debug mode information to the memory device in response to the system-on-chip device being in a debug mode, the memory device storing the debug mode information in response to a triggering signal, the triggering signal being associated with a triggering event, the debug controller reading the memory device and providing the debug mode information external to the system-on-chip device.

9. The device defined by claim 8, wherein the debug mode information represents at least one of a value of a signal associated with the system-on-chip device, value of a register associated with the system-on-chip device, and internal state associated with the system-on-chip device.

10. The device defined by claim 9, wherein the signal associated with the system-on-chip device is not accessible external to the system-on-chip device.

11. The device defined by claim 9, wherein the register associated with the system-on-chip device is not accessible external to the system-on-chip device.

12. The device defined by claim 8, wherein the triggering event comprises at least one of an interrupt, error condition, signal external to the system-on-chip device, signal under software control, condition of the system-on-chip device, and state of the system-on-chip device.

13. The device defined by claim 8, wherein the memory comprises a first memory block and a second memory block, the first memory block and the second memory block storing debug mode information.

14. The device defined by claim 8, wherein the memory comprises a first memory block and a second memory block, the first memory block storing debug mode information, the second memory block storing normal mode information.

15. A computer-readable medium storing instructions that, when executed by a processing device, causes the processing device to perform a computer process that provides debug mode information associated with a system-on-chip device comprising:
storing the debug mode information in on-chip memory internal to the system-on-chip device in response to a triggering signal, the triggering signal being associated with a triggering event and
providing the debug mode information external to the system-on-chip device.

16. The computer-readable medium defined by claim 15, wherein the debug mode information represents at least one of a value of a signal internal to the system-on-chip device, value of a register internal to the system-on-chip device, and internal state associated with the system-on-chip device.

17. The computer-readable medium defined by claim 16, wherein the signal associated with the system-on-chip device is not accessible external to the system-on-chip device.

18. The computer-readable medium defined by claim 16, wherein the register associated with the system-on-chip device is not accessible external to the system-on-chip device.

19. The computer-readable medium defined by claim 15, wherein the triggering event comprises at least one of an interrupt, error condition, signal external to the system-on-chip device, signal under software control, condition of the system-on-chip device, and status of the system-on-chip device.

20. The computer-readable medium defined by claim 15, wherein the memory comprises a first memory block and a second memory block, the computer process further comprising storing debug mode information in the first memory block and the second memory block.

21. The computer-readable medium defined by claim 15, wherein the memory comprises a first memory block and a second memory block, the computer process further comprising:
storing debug mode information in the first memory block; and
storing normal mode information in the second memory block.
